(19) United States
(12) Patent Application Publication
(10) Pub. No.: US 2004/0235518 A1
(43) Pub. Date: Nov. 25, 2004

(54) Hybrid telephone network utilizing wireless link and landline services

(76) Inventors: Fred R. Beyette, Cincinnati, OH (US); Philip A. Wilsey, Cincinnati, OH (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/703,324

(22) Filed: Nov. 7, 2003

Related U.S. Application Data
(60) Provisional application No. 60/472,632, filed on May 22, 2003.

(51) Int. Cl. H04M 1/00

(52) U.S. Cl. 455/554.2; 455/426.2

(57) ABSTRACT

Described are a method and system that combine the features of wireless telephone service and landline telephones through a wired telephone network. The system includes a landline phone and a cell phone coupled to the wired telephone network through a landline interface module and a cell interface module, respectively. The landline interface module generates data for transmission over the wired telephone network to the cell interface module and generates a phone signal at the landline phone in response to data received over the wired telephone network from the cell interface module. The cell interface module generates data for transmission to the landline interface module and generates a phone signal at the cell phone in response to data received from the landline interface module. The cell phone enables communication between the landline phone and a remote cell phone over a wireless link.

### CROSS-REFERENCE TO RELATED APPLICATIONS

This application claims the benefit of the filing date of co-pending U.S. Provisional Application Ser. No. 60/472,632, filed May 22, 2003, titled “Multi-Function Mobile Phone Home Network,” the entirety of which provisional application is incorporated by reference herein.

### FIELD OF THE INVENTION

The invention relates generally to wireless telephone communications. In particular, the invention relates to a system and method for providing access to cellular phone communications through a wired telephone network.

### BACKGROUND

Wireless phones, or cell phones, have gained wide acceptance in recent years. Business people often carry a personal wireless telephone to receive or place business related calls at any time and regardless of location. Students, teenagers and family members are increasingly likely to have their own personal wireless telephone to keep in contact with family members and friends. For many individuals, the cell phone has become the preferred means of communication due to its portability and the wide coverage areas provided by wireless telephone companies.

Typically cell phones are left in one location in a house or apartment when an individual returns home. For example, individuals often prefer not to carry the cell phone about the home. Often the cell phone is coupled to a battery charging unit to recharge the phone battery. If the cell phone remains active (i.e., using battery power and able to receive incoming calls), the phone rings when an incoming call is detected. The user may have to travel to another room in the house to answer the call. Responding to the incoming call can be inconvenient, requiring the user to ascend or descend stairs or walk through multiple rooms to answer the call. Furthermore, if the cell phone is in a distant room or if the background noise is significant, the user may not hear the ring and therefore can miss the incoming call. In other instances, there may be multiple cell phones in the home and it may be difficult to determine which cell phone is receiving the incoming call.

Frequently, homeowners and apartment dwellers subscribe to a landline phone service. Subscribers may rely on the belief that callers will try the landline phone if the cell phones remain unanswered, however, the combination of landline telephone service and wireless telephone service can be expensive.

Accordingly, there exists a need for a system that combines the features of wireless telephone service and landline telephones in the home without incurring high subscription costs. The system should be able to accommodate multiple cell phones for the benefit of several wireless users. The present invention satisfies these needs and provides additional advantages.

### SUMMARY OF THE INVENTION

In one aspect the invention features a hybrid telephone network including a wired telephone nework having a plurality of nodes, and a landline phone and a cell phone coupled to the network at respective nodes. The cell phone is adapted for communicating with a remote cell phone over a wireless link. The landline phone and the cell phone communicate by transmitting information between each other. The cell phone enables communication between the landline phone and a remote cell phone over the wireless link.

In one embodiment the hybrid telephone network also includes a landline interface module coupled to the wired telephone network between the landline phone and the respective node. The landline interface module generates data for transmission over the wired telephone network to the cell phone in response to a phone signal provided by the landline phone. The landline interface module generates a phone signal at the landline phone in response to data received over the wired telephone network from the cell phone. In another embodiment the hybrid telephone network also includes a cell interface module coupled to the wired telephone network between the cell phone and the respective node. The cell interface module generates data for transmission to the landline phone in response to a phone signal provided by the cell phone. The cell interface module generates a phone signal at the cell phone in response to data received from the landline phone.

In another aspect the invention features a landline interface module for coupling a landline phone to a wired telephone network. The landline interface module includes a landline port to receive a phone signal generated at the landline phone, a network port to receive network data generated by a communications device coupled to the wired telephone network, and a processor circuit in communication with the landline port and the network port. The processor circuit generates network data at the network port responsive to the phone signal received at the landline port. The processor circuit generates a phone signal at the landline port responsive to the network data received at the network port. In one embodiment the communications device is a cell interface module.

In another aspect the invention features a cell interface module for coupling a cell phone to a wired telephone network. The cell interface module includes a docking port to receive a phone signal generated at the cell phone, a network port to receive network data generated by a communications device coupled to the wired telephone network, and a processor circuit in communication with the docking port and the network port. The processor circuit generates network data at the network port responsive to the phone signal received at the docking port. The processor circuit generates a phone signal at the docking port responsive to the network data received at the network port. In one embodiment the communications device is a landline interface module. In another embodiment the cell interface module also includes an adapter module coupled to the docking port.

In another aspect the invention features a method of communicating between a landline phone and a cell phone. The method includes generating data in response to a phone signal provided by the landline phone or the cell phone, transmitting the data over the wired telephone network to the cell phone or the landline phone, respectively, and generating a phone signal at the cell phone or the landline phone, respectively, in response to the transmitted data. In one embodiment the method also includes transmitting a landline signal over a plain old telephone service (POTS) line in which the wireless signal is responsive to the generated phone signal. In another embodiment the method also includes transmitting a wireless signal over a wireless link in which the wireless signal is responsive to the generated phone signal.

In another aspect the invention features a method of communicating with a remote phone using a cell phone and a landline phone. The method includes establishing a communication between the cell phone and a remote phone over a wireless link, sending an indication to a wireless provider to transfer the communication to a predetermined landline associated with a landline phone, and routing the communication with the remote phone to the landline phone.

In another aspect the invention features a method of communicating with a remote phone using a cell phone and a landline phone. The method includes establishing a communication between the landline phone and a remote phone over a landline, sending an indication to a landline provider to transfer the communication to a predetermined cell phone, and routing the communication with the remote phone to the predetermined cell phone.

In another aspect the invention features a method of communicating with a remote phone using a cell phone and a landline phone. The method includes providing a communication between the landline phone and a remote phone over a landline, detecting an incoming call from another remote phone on the landline associated with the landline phone, and transferring the communication between the landline phone and the remote phone to a communication between the cell phone and the remote phone over a wireless link in response to the detection of the incoming call. In one embodiment the method also includes establishing a communication between the remote phone placing the incoming call and the landline phone.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is an illustration of an embodiment of a hybrid telephone network in accordance with the invention.

FIG. 2 is a flowchart representation of an embodiment of a method of communicating between a landline phone and a cell phone according to the invention.

FIG. 3 is an illustration of an embodiment of a hybrid telephone system deployed in a building.

FIG. 4 is a graphical representation of the frequency distribution of various communication services provided over a wired telephone network in accordance with the HomePNA™ networking standard.

### DETAILED DESCRIPTION

In brief overview, the present invention relates to a system for providing wireless communications over a hybrid telephone network. The system integrates one or more cell phones at respective nodes in a wired telephone network to make wireless services available through one or more landline phones (e.g., wall phones, desk phones and cordless phones) coupled at respective nodes in the wired telephone network. As used herein, it is to be understood that cell phones include wireless phones and mobile phones, and wireless telephone services includes cellular telephone services and mobile telephone services. A cell interface module (CIM) connects to a cell phone through a CIM docking port and connects to the wired telephone network through a CIM network port. Similarly, a landline interface module (LIM) connects to a landline phone through a LIM landline port and connects to the wired telephone network through a LIM network port. In some embodiments, the wired telephone network is coupled to an analog phone service line (e.g., plain old telephone service line, or “POTS” line) and, in other embodiments, the wired telephone network is coupled to a digital communications line. The CIMs and LIMs allow the landline phones to receive cell phone calls (when one or more cell phones are coupled to a respective CIM), POTS calls, or wireless and POTS calls simultaneously on different landline phones. Moreover, because the landline phones can place or receive calls over the cell phones, users may elect to forego the costs associated with a POTS line subscription.

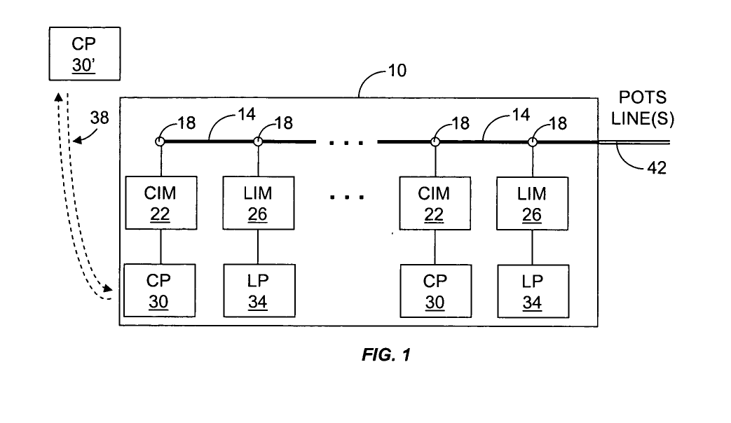

Referring to FIG. 1, an embodiment of a hybrid telephone network 10 constructed in accordance with the invention includes a wired telephone network 14 having multiple nodes 18. CIMs 22 and LIMs 26 are coupled to the wired telephone network 14 at the nodes 18. Cell phones 30 and landline phones 34 are coupled to the wired telephone network 14 through the CIMs 22 and LIMs 26, respectively. In one embodiment, one or more of the CIMs 22 includes a charging unit to charge the battery of a cell phone 30 coupled to the CIM 22 while providing the associated wireless telephone service to landline phones 34 on the wired telephone network 14. In the illustrated embodiment, the wired telephone network 14 is connected to an external network such as one or more POTS subscriber lines 42 to permit the placement and reception of external landline calls.

During operation, when a cell phone 30 coupled to the wired telephone network 14 rings to indicate an incoming call from a remote cell phone 30′ over a wireless link 38, the CIM 22 to which it is docked transmits a ring signal to the LIMs 26, causing the landline phones 34 to ring. Upon answering the incoming call on one of the landline phones 34, the user speaks and listens with the landline phone 34 as if it were the cell phone 30 receiving the call. The receiving cell phone 30 generates a cell phone signal which, for example, can be an analog signal used to drive a speaker in the cell phone 30 and is available at an input/output (I/O) connector on the cell phone 34 that couples to a docking port on the CIM 22. Alternatively, the cell phone signal may be a digital signal available at the I/O connector on the cell phone 30. Processor circuitry in the CIM 22 generates data at the CIM network port in response to the cell phone signal. This data is transmitted over the wired telephone network 14 to the answered landline phone 34. The transmitted data includes address information identifying the answered landline phone 34 so that the transmitted data is received and processed by the proper LIM 26, but is ignored by the other LIMs on the wired telephone network 14.

Processor circuitry in the LIM 26 coupled to the answered landline phone 34 generates a signal at the LIM landline port in response to received network data (i.e., the data transmitted from the CIM 22). This signal can be an analog signal used, for example, to drive a speaker in the handset or body of the landline phone 34. Alternatively, the signal can be a digital signal. Conversation spoken by the user is converted to a landline phone signal in the landline telephone 34. The LIM processor circuitry converts the landline phone signal to data at the LIM network port for transmission back to the active cell phone 30 over the wired telephone network 14. The network data received from the LIM 26 at the network port of the CIM 22 is converted to a phone signal and provided to the cell phone 30 through the CIM docking port. In response, the cell phone 30 transmits information based on the phone signal over the wireless link 38 to the remote cell phone 30′.

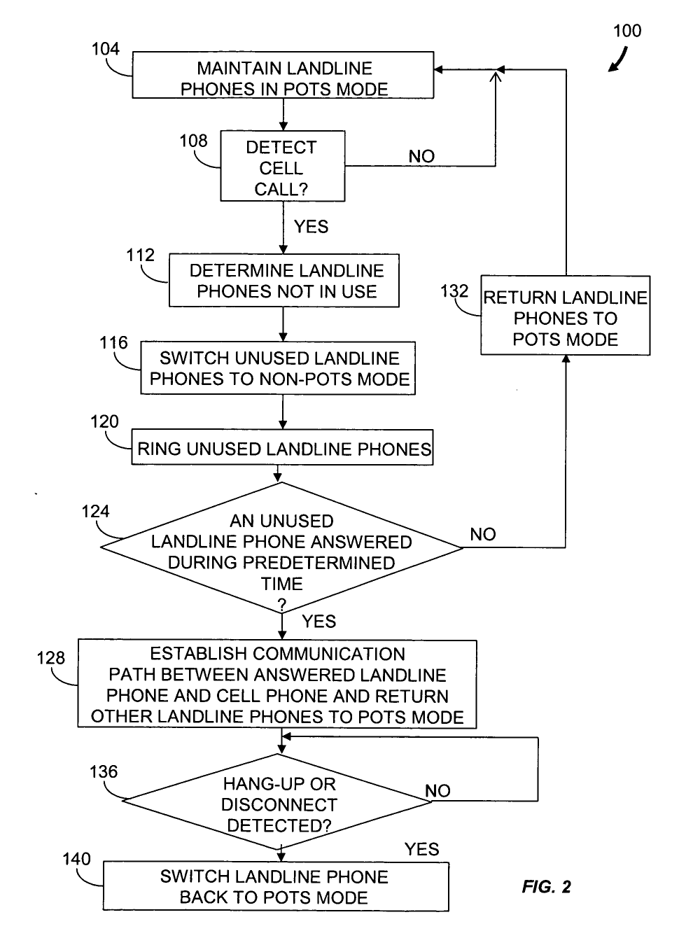

FIG. 2 is a flowchart depicting an embodiment of a method 100 of communicating between a landline phone and a cell phone according to the invention. The method 100 is implemented by the CIMs 22 and LIMs 26 which together act as a telephone switchboard to route calls between the appropriate phones 30, 34. Under circumstances during which none of the cell phones 30 coupled to the wired telephone network 14 are transmitting or receiving over wireless links, the landline phones 34 are maintained (step 104) in POTS mode. If no incoming call is detected (step 108) on any of the cell phones 30 coupled to the network 14, the landline phones 34 remain in POTS mode. If an incoming call is detected (step 108) on a cell phone 30, a determination of which landline phones 34 are not in use is made (step 112) and the unused landline phones 34 are switched (step 116) to non-POTS mode. In other words, the unused landline phones 34 are removed from standard POTS operation and made to respond to network control signals received by their respective LIMs 26. The landline phones 34 in non-POTS mode ring (step 120) in response to ring signals provided by the associated LIMs 22. To prevent the unused landline phones 34 from being trapped in non-POTS mode, only a predetermined time (e.g., 10 seconds) is allowed for the incoming call to be answered. If it is determined (step 124) that one of the unused landline phones 34 is answered during the predetermined time, a communication path is established (step 128) between the answered landline phone 34 and the receiving cell phone 30. However, if no landline phone 34 is answered during the predetermined time, the unused landline phones 34 are returned (step 132) to POTS mode. The communication between the cell phone 30 and the landline phone 34 is monitored through the duration of the call. When a hang-up signal is detected (step 136) by the LIM 26, the associated landline phone 34 is returned (step 140) to POTS mode.

In the above description, the data transferred over the wired telephone network 18 supports a voice conversation between the user of the remote cell phone 30′ and the landline phone 34. It should be recognized by those of skill in the art that other types of data including, for example, video data can be transmitted over the network between the CIM 22 and the LIM 26. For example, the video data can be supplied by the receiving cell phone or over a subscriber landline. In addition, the landline phone 34 can be replaced at its node 18 by another device, such as a modem, videophone, facsimile machine or answering machine.

The CIM 22 and LIM 26 enable standard functions typically performed at one of a cell phone 30 and a landline phone 34 to be implemented at the other phone 30, 34. These functions include generating answer signaling, dialing sequences, and hangup signaling for forwarding from a LIM 26 to a CIM 22. For example, to place a call from a landline phone 34 having conventional telephone service (i.e., coupled to the POTS subscriber line 42) through a cell phone 30, a user picks up the landline phone 34 and hears a dial tone. Using the landline phone keypad, the user enters a dial out sequence to indicate to the associated LIM 26 which cell phone 30 is to be used. The dial out sequence can be an ordered set of predefined keypad entries to indicate that the user elects to make an outgoing call over the identified cell phone 30. A signal is then transmitted to the respective CIM 22. A busy signal is transmitted from the CIM 22 back to the LIM 26 if the selected cell phone 30 is in use. Similarly, if the selected cell phone 30 is not docked in its CIM 22, a phone unavailable signal is transmitted from the CIM 22 back to the LIM 26. If the cell phone 30 is available, a communication channel is established between the two phones 30, 34 and the user enters the phone number using the keypad on the landline phone 34.

A range of function sequences are defined to activate cell phone functions from the landline phone 34. Sequences, as used herein, include a single keypad entry or a predefined set of keypad entries in a specific order. As described above, one sequence indicates that an outgoing call is to be placed over an identified cell phone 30. A user can make keypad entries at the landline phone 34 to enable other operational features of the cell phone 30. For example, voice-activated dialing available through the cell phone 30 can be accessed through the landline phone 34 even though the landline phone 34 may not independently provide voice-activated functionality.

The landline phone 34 can be equipped with a display that is suitable for presenting cell phone display features. Thus the user can see a wide range of display features available on a variety of cell phones, including displays relating to signal strength, battery charge, time, caller identification (ID), timers, alarms, setup menus and settings, call histories, and usage details. Other features that can be displayed include phone and address books, games, schedules and date books, calculators and web browsers. In some instances the features displayed on the cell phone may correspond to services not purchased or otherwise made available over the POTS line.

Any number of cell phones 30 and landline phones 34 are contemplated according to the invention. Moreover, the cell phones 30 and landline phones 34 can be of varying models and provided by different manufacturers. FIG. 3 illustrates an example of a hybrid telephone system as deployed in a single building 46. Three rooms 50 located upstairs in the building 46 have CIMs 22 for connecting cell phones 30 to the wired telephone network 14. Only two of the CIMs 22 are coupled to cell phones, the uncoupled cell phone 30 may be located with an individual not present in the building 46. One of the upstairs rooms 46 also has a landline telephone 34 connected to the wired telephone network 14 through a LIM 26. Two of the downstairs rooms 50 have LIMs 26 for connecting a fixed phone (e.g., desk phone or wall phone) 34′ and a cordless phone to the wired telephone network 14. The cordless phone includes a base station 54 and a portable handset 58. As shown, the handset 58 is separate from the base station 54 and is located in the left downstairs room 50.

In the illustrated example the hybrid telephone network supports incoming calls received on multiple cell phones 30 at the same time. In effect, the CIMs 22 and LIMs 26 cooperate to perform switching functions and establishing one or more communication channels between the phones 30, 34 over the wired telephone network 14. In addition, the hybrid telephone network supports a simultaneous landline call placed or received over the POTS line 42. A second simultaneous landline call is possible if a second POTS line 42 is coupled to the wired telephone network 14. Although the illustration is limited to a single building 46, in other embodiments the wired telephone network 14 extends to multiple buildings such as in a campus environment.

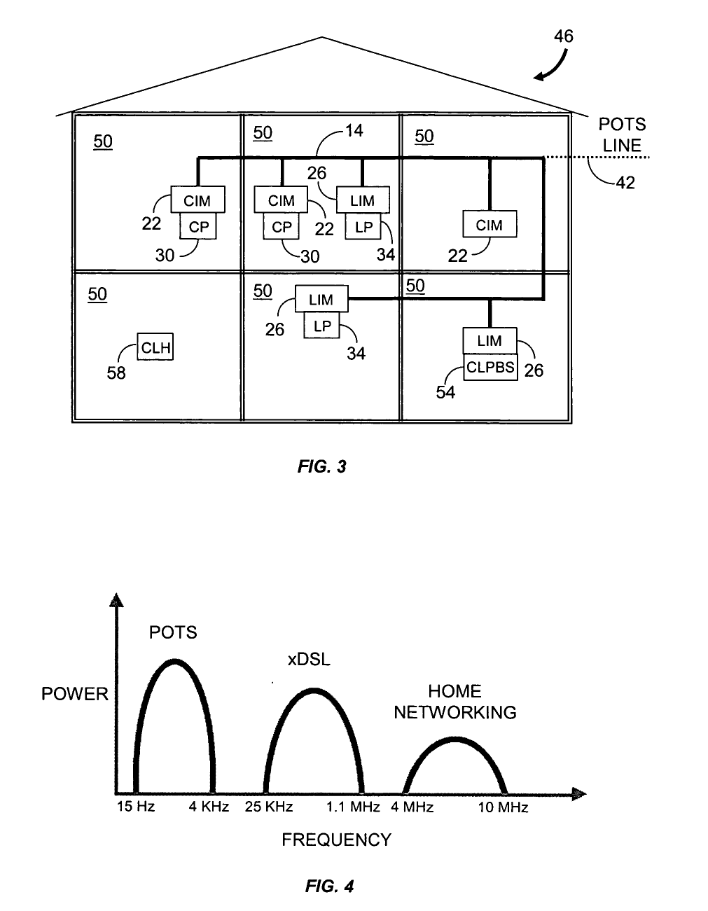

Referring to FIG. 4, in one embodiment the hybrid telephone network is implemented using frequency division multiplexing (FDM) to separate various signals carried over the wired telephone network 14. In the illustrated embodiment, the FDM is defined according to the HomePNA™ (Home Phoneline Networking Association) networking standard and does not interfere with fax machines and other computer accessories coupled to the wired telephone network 14, or Internet dial-up connections utilizing the wired telephone network 14. Analog telephone communications (i.e., POTS telephony) are at the lower end of the frequency spectrum. Various types of digital subscriber lines (xDSL) are accommodated at higher frequencies, up to 1.1 MHz. Communications between components on the wired telephone network 14 are permitted between 4 MHz and 10 MHz.

The hybrid telephone network 14 can be implemented using a variety of techniques. For example, the data can be transmitted over the wired telephone network 14 as data packets. Alternatively, the data can be transmitted as a frequency modulated carrier signal. In this alternative embodiment the network 14 supports communications between multiple cell phones 30 and landline phones 34 on the wired telephone network 14. Each communication between a pair of phones 30, 34 is realized through modulation of a unique carrier frequency. In another embodiment, the wired telephone network 14 is an optical fiber based network in which data is transmitted through modulation of optical carrier signals. In this embodiment, simultaneous communications between landline phones 34 and/or between landline phones 34 and cell phones 30 are supported by using a separate wavelength (i.e., optical carrier frequency) for each communication channel.

The cell phones 30 are not restricted for use with a specific CIM 22. Rather, a cell phone 30 can be docked (i.e., coupling to the wired telephone network 14 at the respective node 18) in any available CIM 22 on the wired telephone network 14. In operation, each CIM 22 interrogates the cell phone 30 after docking in the CIM 22 to determine its identity. Interrogation includes transmitting a request code to the docked cell phone 30 via the I/O pins to retrieve the unique identification number, or serial number, of the cell phone 30. The CIM 22 associates the returned identification number with a specific access code used with the hybrid telephone network 10. Subsequently, data packets or data frames transmitted over the wired telephone network 14 are examined by the CIM 22 to see if their headers contain the access code corresponding to the docked cell phone 30. If the corresponding access code is detected, the CIM 22 processes the associated packets or frames to enable communication between the cell phone 30 and a respective landline phone 34.

Different variations of CIMs 22 are possible. In one embodiment, the CIM 22 has multiple docking ports for receiving a cell phone 30. The docking ports can be commonly configured if all the cell phones 30 to be used with the network 10 are of a similar type. Alternatively, the docking ports can have different I/O connectors so that the CIM 22 can be used with different types of cell phones 30.

Features offered by cell phones 30 can vary significantly between models. Users may want to replace their current cell phones 30 to take advantage of additional operational and display features available in newer models. Newer model cell phones 30 may have different I/O pin configurations from the cell phone 30 being replaced. An adapter module can be connected to the I/O connector in the docking port of the CIM 22 to provide the proper pin out configuration for the replacement cell phone 30. Advantageously, the adapter module can be purchased when the user purchases or the new cell phone 30, thus avoiding the need to purchase a new CIM 22. The adapter module can include circuitry to accommodate operations and/or features that cannot be provided by a single circuit in the CIM 22. For example, if the ring detection circuit differs according to phone type, the adapter module can include the ring detection circuit for the new cell phone 30. In another example, the charging requirements can differ according to manufacturers or even according to phone model. Circuitry can be included in the adapter module to convert a charging voltage provided for one I/O pin of the docking port to a different voltage. In addition, the charging voltage can be provided on a different I/O pin of the adapter module.

According to another variation, the functionality of distributed CIMs 22 holding only a single cell phone 30 can be provided by a single CIM 22 having multiple docking ports. This multi-port CIM 22 is coupled to the wired telephone network 14 at a single node 18 and routes communications between its docked cell phones 30 and their respective landline phones 34. This permits the users to dock their cell phones 30 at one convenient location within the building. For example, the users might dock their cell phones in a multi-port CIM 22 located at the main entry to the building 46.

The hybrid telephone network of the present invention can be used to accommodate the needs of a user who may only have access to the wired telephone network for a limited time. For example, a user may already be engaged in a conversation with another individual over a wireless link. The user arrives enters the building and inserts the cell phone into a CIM 22 and subsequently picks up the call on a landline phone 34. An indication that the cell phone 30 has been docked into its CIM 22 is sent to the associated wireless telephone company, either through the active wireless link or through the building's landline. This procedure allow the wireless telephone company to replace the wireless link between the cell phone 30 and the associated cell tower with a link over a landline, potentially improving the clarity of the call and reducing the associated costs to the wireless telephone company and the user. In addition, the traffic capacity of the associated cell tower supporting the initial portion of the call is increased by the routing.

Similarly, a user that has initiated or received a call over a landline phone 34 may wish to continue the call after leaving the building. In this instance, an indication is sent to the wireless telephone company so that the landline call can be switched to utilize a wireless link for continuation of the call as the user departs with the cell phone 30. The indication is transmitted over the landline before termination of the landline connection or, alternatively, the indication is transmitted over a wireless link to the wireless telephone company. In one embodiment, the switch from landline service to wireless service is initiated automatically, for example, upon replacement of the handset of a landline phone 34 into its cradle and subsequent removal of a cell phone 30 from its CIM 22. From the perspectives of the two users, the transition from the landline phone 34 to the cell phone 30 is transparent.

In another embodiment, a user can associate a cell phone telephone number with a landline telephone number so that an incoming call is first provided to landline phones 34 associated with the landline number. This embodiment is useful, for example, if the quality of calls made or received using the cell phone 30 in the building is poor. Optionally, the incoming call is switched to a wireless link if the call is not answered on a landline phone 34 after a predetermined time. In a further option, if an incoming call is detected on the landline while a previous call to the cell phone 30 is using the landline, the previous call is transferred over a wireless link to the cell phone 30 to make the incoming call available for answering on a landline phone 34. In another implementation, if an incoming call to a landline number is detected during an ongoing landline call, the incoming call can be automatically routed through a wireless link to a cell phone 30 in the building.

While the invention has been shown and described with reference to specific preferred embodiments, it should be understood by those skilled in the art that various changes in form and detail may be made therein without departing from the spirit and scope of the invention as defined by the following claims.

What is claimed is:

1. A hybrid telephone network comprising:
a wired telephone network having a plurality of nodes;
a landline phone coupled to the wired telephone network at one of the nodes;
a cell phone coupled to the wired telephone network at another of the nodes, the cell phone adapted for communicating with a remote cell phone over a wireless link, the landline phone and the cell phone communicating with each other by transmitting information therebetween, the cell phone enabling communication between the landline phone and a remote cell phone over the wireless link.

2. The hybrid telephone network of claim 1 wherein the information comprises data packets.

3. The hybrid telephone network of claim 1 wherein the landline phone has a display that is suitable for display of cell phone display features.

4. The hybrid telephone network of claim 1 wherein the landline phone has an operational feature to provide an operational feature of the cell phone.

5. The hybrid telephone network of claim 1 further comprising a landline interface module coupled to the wired telephone network between the landline phone and the one of the nodes, the landline interface module generating data for transmission over the wired telephone network to the cell phone in response to a phone signal provided by the landline phone, the landline interface module generating a phone signal at the landline phone in response to data received over the wired telephone network from the cell phone.

6. The hybrid telephone network of claim 5 wherein the data transmitted over the wired telephone network comprise data packets.

7. The hybrid telephone network of claim 5 wherein the data is transmitted over the wired telephone network as a modulated optical carrier signal.

8. The hybrid telephone network of claim 5 wherein the data is transmitted over the wired telephone network as a frequency modulated carrier signal.

9. The hybrid telephone network of claim 5 wherein at least one of the phone signal provided by the landline phone and the phone signal generated by the landline interface module is an analog signal.

10. The hybrid telephone network of claim 5 wherein at least one of the phone signal provided by the landline phone and the phone signal generated by the landline interface module is a digital signal.

11. The hybrid telephone network of claim 5 wherein the phone signal provided by the landline phone comprises video data.

12. The hybrid telephone network of claim 1 further comprising a cell interface module coupled to the wired telephone network between the cell phone and the another of the nodes, the cell interface module generating data for transmission to the landline phone in response to a phone signal provided by the cell phone, the cell interface module generating a phone signal at the cell phone in response to data received from the landline phone.

13. The hybrid telephone network of claim 12 wherein the data transmitted over the wired telephone network comprise data packets.

14. The hybrid telephone network of claim 12 wherein the data is transmitted over the wired telephone network as a modulated optical carrier signal.

15. The hybrid telephone network of claim 12 wherein the data is transmitted over the wired telephone network as a frequency modulated carrier signal

16. The hybrid telephone network of claim 12 wherein at least one of the phone signal provided by the cell phone and the phone signal generated by the cell interface module is an analog signal.

17. The hybrid telephone network of claim 12 wherein at least one of the phone signal provided by the cell phone and the phone signal generated by the cell interface module is a digital signal.

18. The hybrid telephone network of claim 12 wherein the phone signal provided by the cell phone comprises video data.

19. The hybrid telephone network of claim 1 wherein the cell interface module comprises a cell phone charging unit.

20. The hybrid telephone network of claim 1 further comprising one of a facsimile machine, a modem and an answering machine coupled to a respective one of the nodes.

21. The hybrid telephone network of claim 1 further comprising at least one other landline phone coupled to the wired telephone network at a respective node, the landline phones and the cell phone communicating with each other by transmitting voice data packets from the cell phone to each of the landline phones and from each landline phone to the cell phone and the other landline phones, the cell phone providing communication between the landline phones and a remote cell phone over the wireless link.

22. The hybrid telephone network of claim 1 wherein the landline phone is a cordless phone.

23. The hybrid telephone network of claim 1 wherein the wired telephone network is coupled to a POTS line at one of the nodes.

24. The hybrid telephone network of claim 23 wherein the communication occurs between a remote landline phone and the landline phone over the POTS line and the wired telephone network.

25. The hybrid telephone network of claim 23 wherein communication occurs between a remote landline phone and the cell phone while the cell phone is removed from the wired telephone network, the communication transmitted over the POTS line, the wired telephone network and the wireless link.

26. The hybrid telephone network of claim 23 wherein communication transitions between a first communication mode and a second communication mode, the first communication mode including the transfer of communication data between a remote landline phone and the landline phone, the second communication mode including the transfer of communication data between the remote landline phone and the cell phone while the cell phone is removed from the wired telephone network.

27. A hybrid telephone network comprising:
a wired telephone network having a plurality of nodes;
at least one landline phone coupled to the wired telephone network at a respective node;
at least one cell phone coupled to the wired telephone network at a respective node, each of the at least one cell phones adapted for communicating with a remote cell phone over a respective wireless link, the at least one landline phone and the at least one cell phone communicating with each other by transmitting information therebetween.

28. The hybrid telephone network of claim 27 wherein a selection of the one of the cell phones to use to establish a wireless link is made at one of the at least one landline phones.

29. The hybrid telephone network of claim 27 wherein a selection of the one of the cell phones to use to establish a wireless link is made at one of the at least one cell phones.

30. The hybrid telephone network of claim 27 wherein communication transitions between a first communication mode and a second communication mode, the first communication mode including the transfer of communication data between a remote cell phone and one of the at least one landline phones, the second communication mode including the transfer of communication data between the remote cell phone and one of the at least one cell phones while the one of the at least one cell phones is removed from the wired telephone network.

31. The hybrid telephone network of claim 27 wherein the wired telephone network comprises an optical fiber network and wherein the transmitting of information between the at least one landline phone and the at least one cell phone is an optical transmission.

32. The hybrid telephone network of claim 31 wherein a first one of the at least one landline phone communicates with a first one of the at least one cell phone on a first optical wavelength and a second one of the at least one landline phone communicates with a second one of the at least one cell phone on a second optical wavelength.

33. The hybrid telephone network of claim 27 wherein a first one of the at least one landline phone communicates with a first one of the at least one cell phone according to a frequency modulation of a first carrier frequency and a second one of the at least one landline phone communicates with a second one of the at least one cell phone according to a frequency modulation of a second carrier frequency.

34. A landline interface module for coupling a landline phone to a wired telephone network, comprising:
a landline port to receive a phone signal generated at the landline phone;
a network port to receive network data generated by a communications device coupled to the wired telephone network; and
a processor circuit in communication with the landline port and the network port, the processor circuit generating network data at the network port responsive to the phone signal received at the landline port, the processor circuit generating a phone signal at the landline port responsive to the network data received at the network port.

35. The landline interface module of claim 34 wherein the communications device is a cell interface module.

36. The landline interface module of claim 34 wherein the network data comprise data packets.

37. The landline interface module of claim 34 wherein the data packets comprise address data.

38. A cell interface module for coupling a cell phone to a wired telephone network, comprising:
a docking port to receive a phone signal generated at the cell phone;
a network port to receive network data generated by a communications device coupled to the wired telephone network; and
a processor circuit in communication with the docking port and the network port, the processor circuit generating network data at the network port responsive to the phone signal received at the docking port, the processor circuit generating a phone signal at the docking port responsive to the network data received at the network port.

39. The cell interface module of claim 38 wherein the communications device is a landline interface module.

40. The cell interface module of claim 38 wherein the network data comprise data packets.

41. The cell interface module of claim 38 wherein the network data comprise address data.

42. The cell interface module of claim 38 further comprising an adapter module coupled to the docking port.

43. A method of communicating between a landline phone and a cell phone, the landline phone and the cell phone each being coupled to a wired telephone network, the method comprising:
generating data in response to a phone signal provided by one of the landline phone and the cell phone;
transmitting the data over the wired telephone network to the other of the landline phone and the cell phone; and
generating a phone signal at the other of the landline phone and the cell phone in response to the transmitted data.

44. The method of claim 43 further comprising transmitting a landline signal over a POTS line, the landline signal being responsive to the generated phone signal.

45. The method of claim 43 further comprising transmitting a wireless signal over a wireless link, the wireless signal being responsive to the generated phone signal.

46. A method of communicating between a landline phone and a cell phone, the landline phone and the cell phone each being coupled to a wired telephone network, the method comprising:
detecting the presence of an incoming call on the cell phone;
providing a ring signal to the landline phone if the landline phone is not in use; and
establishing a communication path between the landline phone and the cell phone over the wired telephone network in response to an answering of the landline phone.

47. The method of claim 46 wherein a plurality of landline phones are coupled to the wired telephone network and wherein the provision of a ring signal comprises providing a ring signal to each of the landline phones that are not in use.

48. The method of claim 47 further comprising switching each of the landline phones that is not in use from a POTS mode to a networked mode upon the detection of the presence of the incoming call.

49. The method of claim 48 wherein one of the landline phones is answered during a predetermined time, the method further comprising switching each of the landline phones that is unanswered to the POTS mode.

50. The method of claim 48 further comprising switching each of the landline phones from the networked mode to the POTS mode if none of the landline phones that are not in use are answered during a predetermined time.

51. A method of communicating with a remote phone using a cell phone and a landline phone, the method comprising:
establishing a communication between the cell phone and a remote phone over a wireless link;
sending an indication to a wireless provider to transfer the communication to a predetermined landline associated with a landline phone; and
routing the communication with the remote phone to the landline phone.

52. The method of claim 51 further comprising routing the communication between the remote phone and the landline phone to a communication over a wireless link between the cell phone and the remote phone if an incoming call is detected on the landline during the communication between the remote phone and the landline phone.

53. The method of claim 51 wherein the sending of the indication comprises transmitting the indication over the wireless link.

54. The method of claim 51 wherein the sending of the indication comprises transmitting the indication over a landline associated with the landline phone.

55. A method of communicating with a remote phone using a cell phone and a landline phone, the method comprising:
establishing a communication between the landline phone and a remote phone over a landline;
sending an indication to a landline provider to transfer the communication to a predetermined cell phone; and
routing the communication with the remote phone to the predetermined cell phone.

56. The method of claim 55 wherein the sending of the indication comprises transmitting the indication over the landline.

57. The method of claim 55 wherein the sending of the indication comprises transmitting the indication over a wireless link initiated by the cell phone.

58. The method of claim 55 wherein the sending of the indication is performed after the expiration of a predetermined time.

59. A method of communicating with a remote phone using a cell phone and a landline phone comprising:
providing a communication between the landline phone and a remote phone over a landline;
detecting an incoming call from another remote phone on the landline associated with the landline phone; and
transferring the communication between the landline phone and the remote phone to a communication between the cell phone and the remote phone over a wireless link in response to the detection of the incoming call.

60. The method of claim 59 further comprising establishing a communication between the another remote phone and the landline phone.
